(19) United States
(12) Patent Application Publication
(10) Pub. No.: US 2016/0148086 A1
(43) Pub. Date: May 26, 2016

(54) Radio Frequency Identification Tag

(71) Applicants: Ross Robert CLARKE, Auckland (NZ); Pierce Robert CLARKE, Auckland (NZ)

(72) Inventors: Ross Robert Clarke, Auckland (NZ); Pierce Robert Clarke, Auckland (NZ)

(21) Appl. No.: 14/899,689

(22) PCT Filed: Jun. 4, 2014
(86) PCT No.: PCT/NZ2014/000103

§ 371 Date: Dec. 18, 2015

(30) Foreign Application Priority Data
Jun. 19, 2013 (NZ) 612169
Oct. 8, 2013 (NZ) 616413

(51) Int. Cl. G06K 19/077

(52) U.S. Cl. CPC G06K 19/07749

(57) ABSTRACT

The invention provides a radio frequency identification (RFID) tag particularly suitable for use as a linen or laundry tag, and methods for producing RFID tags. The RFID tag in one embodiment comprises a backing layer, a first adhesive layer overlaying the backing layer, an RFID transponder and antenna overlaying the first adhesive layer, and a second adhesive layer overlaying the RFID transponder and antenna. The layers are laminated together, hermetically sealing the RFID transponder and antenna within the RFID tag.

### FIELD OF THE INVENTION

This invention relates to a radio frequency identification (RFID) tag. More particularly, though not exclusively, the invention relates to washable laundry RFID tags and methods for producing RFID tags.

### BACKGROUND

Identification and/or tracking of items is important in a number of fields for inventory management, theft detection, and/or process optimisation, for example. Items are commonly identified visually using an identification number or optically using a bar-code scanner. Visual identification and manual record-keeping is prone to human error. While the use of bar-codes ameliorates this issue, both methods require a line of sight to the identifier.

Radio frequency identification tags (RFID) provide a convenient alternative to prior art methods of identification which have been widely adopted in some industries. The RFID tags can be scanned wirelessly without need for a direct line of sight, and at a range of several meters or more depending upon the RFID tag and reader hardware. Passive tags in particular are relatively inexpensive, unobtrusive, and convenient as they do not require a battery, but are powered parasitically by the RFID reader device upon interrogation.

Washable laundry RFID tags have been specifically adapted for use in identifying and tracking laundry articles such as bed linen/bedding/bedclothes (including but not limited to sheets, pillowcases, blankets, valences, and duvet covers), tablecloths, towels, robes, clothing and the like which are subjected to considerable moisture, heat, friction, and deformation in the repeated washing, drying, and/or ironing/pressing processes, and during use. Their use is increasingly popular with commercial customers, including but not limited to hotels, in managing their inventory of uniforms and bed linen in particular.

Laundry tags must be waterproof and durable to protect the electronics (RFID transponder and antenna), which should ideally remain readable for in excess of 200 wash/dry/use cycles.

One of the problems which has limited the uptake of RFID laundry tags is that they are best suited for attachment to the laundry article, such as bed linen, during manufacture, and are often unsuitable or impractical for retrofitting to existing linen. Many hotels have a large inventory of bed linen without laundry tags, which they are generally unwilling to entirely replace due to the cost of doing so. Without RFID tags on all bed linen, however, investment in the required readers and other infrastructure often cannot be justified.

A first type of prior art flexible washable laundry tag typically comprises an RFID transponder and a substantially planar foil antenna enclosed in a synthetic rubber housing. This type of laundry tag is generally enclosed in a pocket, label, or hem sewn into the laundry article, and is thus generally only attached conveniently upon manufacture of the laundry article. The laundry tag is not generally secured inside the laundry article, and may therefore move within a hem, for example, in use. This may increase wear on the laundry tag and/or laundry item, and be undesirable for aesthetic and tactile reasons. The laundry tag itself cannot be sewn onto the laundry article without damaging the tag or compromising the hermetic seal of the housing, and is not provided with any other means for affixing the tag to the laundry article.

Furthermore, the housing of this type of laundry tag typically comprises a two-piece moulding, but the surface area for adhesion/welding between the two pieces is limited by the central planar foil antenna therebetween which results in a weakness around the perimeter which may crack and allow moisture ingress. The antenna may corrode and significantly reduce the range at which the tag may be successfully interrogated, if not fail entirely.

Another type of existing washable laundry tag comprises an RFID transponder and an antenna provided on a poly-cotton backing to be attached to laundry articles by an adhesive or stitching. The antenna is stitched into the poly-cotton backing. This tag may be retrofitted to existing bed linen or attached to new linen upon manufacture.

One potential problem with this type of laundry tag is that the stitching securing the antenna to the poly-cotton backing remains visible and it is highly apparent that the tag comprises an RFID transponder. The owner of the laundry article might prefer to disguise that fact, or otherwise prefer that such stitching is not apparent for purely aesthetic reasons. Another potential problem with this prior art laundry tag arises from exposure to heat and bleach from repeated washing and drying cycles gradually causing unsightly discolouration of the poly-cotton backing. This discolouration generally ranges from a beige/taupe colour to orange depending upon the particular adhesive used or the reaction to heat from the build-up of bleaches in the poly-cotton material. To disguise this discolouration, it is common for such laundry tags to be enclosed in a pocket of some other material which will not discolour. However, it is time-consuming, inconvenient, and more expensive to attach laundry tags to existing bed linen in this way, in particular for retrofitting.

In some circumstances it may further be desired to supplement the RFID tag with markings such as a visual identification means or their own logo/branding, for example. However, the most convenient method for marking tags, by printing directly to the backing layer of the tag, has hitherto not been practical with the poly-cotton backing RFID tags of the prior art. Instead, the prior art RFID tags have generally been supplemented by an additional traditional woven and embroidered or printed label provided alongside the RFID tag to add the required visual information to the garment or linen item. Regardless, the individual RFID laundry tags of the prior art cannot be conveniently printed in large quantities due to difficulties in feeding the RFID tags through a printer.

The prior art laundry tags may also suffer from the disadvantage of limited durability, most commonly due to broken connections in the antenna from repeated flexing and twisting of the tag, in particular at a point of connection with the RFID transponder which may be rigid. Alternatively, or additionally, the laundry tags of the prior art may permit relative movement of the RFID transponder and antenna which has also been found to contribute to failure of the tag.

### OBJECT OF THE INVENTION

It is therefore an object of the present invention to provide a radio frequency identification (RFID) tag and/or a method for producing RFID tags which overcome or at least ameliorate one or more disadvantages of the prior art, or alternatively to at least provide the public with a useful choice.

Further objects of the invention will become apparent from the following description.

### SUMMARY OF INVENTION

In a first aspect the invention may broadly be said to consist in a radio frequency identification (RFID) tag comprising:
a backing layer;
a first adhesive layer overlaying the backing layer;
an RFID transponder coupled to an antenna, overlaying the first adhesive layer; and
a second adhesive layer overlaying the RFID transponder and antenna.

Preferably the backing layer, first adhesive layer, RFID transponder, antenna, and second adhesive layer are laminated together with the RFID transponder and antenna hermetically sealed between the first and second adhesive layers.

Preferably the RFID tag further comprises an outer layer overlaying the second adhesive layer, wherein the adhesive layers are laminated between the backing layer and outer layers.

Preferably the backing layer and/or outer layer is polymeric.

Preferably the first and second adhesive layers hermetically seal the RFID transponder and the antenna within the RFID tag.

Preferably the backing layer and/or outer layer comprises a fluid-impervious, non-hygroscopic polymeric material. More particularly, the polymeric backing layer preferably comprises polyvinyl chloride (PVC), low-density polyethylene (LDPE), polyurethane (PU), polyester, or more preferably polypropylene (PP). The backing layer may comprise a woven polyester fabric, for example. Alternatively, the polymeric layers may comprise any suitable alternative polymer material.

Alternatively, the backing layer and/or outer layer may comprise cotton, poly-cotton, or any other suitable natural or synthetic material. Once the tag is made, the adhesive layers melt into the backing and/or outer layers and make the tag waterproof.

Preferably the backing and/or outer layer comprises a printable medium.

Preferably the first and/or second adhesive layers comprise a heat-activated adhesive material. More particularly, the adhesive layer preferably comprises polyurethane (PU) or an acrylic polymer.

Preferably the antenna comprises an elongate multi-strand stainless steel wire. The wire is preferably between 0.3 and 0.5 mm in diameter, and encapsulated in insulation. The insulation may be nylon, for example.

Preferably one of the first or second adhesive layers comprises a reinforced adhesive layer. In particular, the first adhesive layer preferably comprises a reinforcing mesh embedded at least in part in the adhesive material. The reinforcing mesh may comprise a polyester or poly-cotton textile, for example, but other materials and meshes may alternatively be used.

Preferably the antenna comprises an elongate conductive wire stitched to the reinforced adhesive layer, and more particularly to the reinforcing mesh.

Alternatively, the antenna may comprise a foil antenna.

Preferably the RFID transponder is inductively coupled with the antenna. In particular, the antenna preferably loops at least partially about the circumference of the RFID transponder.

Preferably the RFID tag comprises printed markings on the backing and/or outer layer.

Preferably the tag comprises a laundry tag, or more particularly a linen and/or garment tag.

Preferably the antenna comprises a substantially elongate conductive wire having a central looped portion, arcuate portions towards opposing ends of the elongate wire, and substantially linear intermediate portions between the central looped portion and each of the arcuate portions. The ends of the wire preferably terminate facing each other and the central looped portion, parallel with the substantially linear intermediate portions.

In a second aspect the invention may broadly be said to consist in a radio frequency identification (RFID) tag comprising a polymeric backing layer, a first layer of adhesive material, an RFID transponder and associated antenna, and a second layer of adhesive material, wherein the backing and adhesive layers are laminated together with the RFID transponder and antenna hermetically sealed between the first and second adhesive layers.

Preferably the first adhesive layer is reinforced with a reinforcing mesh at least partially embedded within at least one of the first or second layers of adhesive material.

Preferably the antenna is stitched to the first adhesive layer, and more particularly to the reinforcing mesh.

Preferably the adhesive material comprises a heat-activated adhesive material. More particularly, the adhesive material preferably comprises polyurethane or an acrylic polymer.

Preferably the RFID transponder and antenna are inductively coupled.

Preferably the RFID tag further comprises a polymeric outer layer adjacent the second adhesive layer.

In a third aspect the invention may broadly be said to consist in a radio frequency identification (RFID) tag array comprising a plurality of adjacent separable RFID tags according to the first or second aspects of the invention.

Preferably the RFID tag array is adapted for feeding through a printer to provide markings on one or more of the plurality of RFID tags. Alternatively, or additionally, the RFID tag array may comprise pre-printed markings on one or more of the plurality of RFID tags.

Preferably the RFID tag array comprises a unitary backing sheet, a first unitary adhesive sheet, and a second unitary adhesive sheet, wherein the backing and first and second adhesive sheets form the respective backing and first and second adhesive layers of each of the plurality of RFID tags.

Preferably the backing sheet comprises a polymeric material which may be printed to using an inkjet printer, laser printer, or more preferably a thermal transfer printer.

Preferably the plurality of RFID tags are each separably partitioned by perforations in one or more of the backing and adhesive sheets.

Preferably the RFID tag array further comprises a plurality of indexing apertures along at least one edge of the array, and more preferably along opposing longitudinal edges of the array. Respective rows of the indexing apertures are preferably partitioned from the plurality of RFID tags by perforations in the backing sheet.

Alternatively, there may be provided at least one gap or indent in the backing sheet adjacent each of the plurality of RFID tags.

Alternatively, the plurality of RFID tags may be removably attached to a disposable membrane with a spacing between adjacent RFID tags in a longitudinal direction of the RFID tag array. The disposable membrane preferably comprises a strip of paper to which the RFID tags are removably attached by an adhesive. Preferably the disposable membrane is at least partially translucent.

The indexing apertures, gap(s) or indent(s), and/or spacing(s) provide a means by which the RFID tag array may be fed through a printer, in particular by a tractor-feed mechanism, and/or a means for sensing movement of the RFID tag array by way of light sensing.

In a fourth aspect the invention may broadly be said to consist in a method for producing a radio frequency identification (RFID) tag, comprising:
providing consecutive layers of a backing layer, a first adhesive layer overlaying the backing layer, an RFID transponder and an associated antenna overlaying the first adhesive layer, and a second adhesive layer overlaying the RFID transponder and the antenna; and
bonding the backing layer and adhesive layers together to hermetically seal the RFID transponder and antenna within the RFID tag.

The backing layer and adhesive layers may be bonded together simultaneously or consecutively.

Preferably the method further comprises providing an outer layer overlaying the second adhesive layer, and bonding the outer layer to the second adhesive layer.

Preferably the backing layer and/or outer layer comprises a polymeric material.

Preferably at least one of the first and second adhesive layers comprises a reinforcing mesh.

Preferably the method further comprises a step of stitching the antenna to the reinforcing mesh prior to bonding the layers together.

Preferably the step of bonding the layers comprises welding the layers together. More particularly, the welding preferably comprises thermal or ultrasonic welding.

Preferably the polymeric backing layer and/or outer layer comprises a non-hygroscopic material. More particularly, the polymeric backing and/or outer layer preferably comprises polyvinyl chloride (PVC), low-density polyethylene (LDPE), or more preferably polypropylene (PP).

Preferably the adhesive layer(s) comprise a heat-activated adhesive material. More particularly, the adhesive layer preferably comprises polyurethane or an acrylic polymer.

Preferably the method further comprises a step of printing on the polymeric backing and/or outer layer.

Preferably the method comprises producing a plurality of RFID tags by providing substantially unitary polymeric backing and first and second adhesive sheets, wherein portions of the polymeric backing and first and second adhesive sheets form respective polymeric backing and first and second adhesive layers of the plurality of RFID tags.

Preferably the method further comprises providing perforations in at least one of the sheets, partitioning the plurality of RFID tags.

Preferably the method further comprises providing a plurality of indexing apertures along at least one edge of at least one of the sheets, and more preferably along opposing longitudinal edges. The method preferably further comprises providing perforations in said at least one sheet, partitioning the apertures from the plurality of RFID tags.

Alternatively, the method may comprise producing a plurality of individual RFID tags and removably attaching the plurality of RFID tags to a disposable membrane.

Preferably the antenna comprises a conductive wire arranged to have a central loop portion and inwardly-directed arcuate portions towards opposing ends of the wire.

Preferably the method further comprises attaching the or each RFID tag to a laundry article.

Preferably the RFID tag is attached to the laundry article by positioning the RFID with the exposed second adhesive layer adjacent the laundry article, and applying heat sufficient to adhere the second adhesive layer to the laundry article.

Alternatively, the RFID tag may be attached to the laundry article by stitching it to the laundry article.

In a fifth aspect the invention may broadly be said to consist in a method for producing a radio frequency identification (RFID) tag by laminating and hermetically sealing an RFID transponder and antenna between layers of an adhesive material.

In a sixth aspect the invention may broadly be said to consist in a radio frequency identification (RFID) tag array comprising a plurality of RFID tags each comprising an RFID transponder and associated antenna hermetically sealed between first and second adhesive layers, provided on a unitary backing sheet.

Preferably the backing sheet is adapted for feeding through a printer to provide printed markings on the tag array, and more preferably on the backing sheet. Alternatively, or additionally, the backing sheet may comprise pre-printed markings.

Preferably each of the plurality of RFID tags are partitioned from one another by perforations in the backing sheet whereby individual RFID tags may be torn from the array along said perforations. The backing sheet may thus form a backing layer of the plurality of RFID tags, and preferably comprises a polymeric material.

Alternatively, each of the plurality of RFID tags may be separately and removably attached to the backing sheet. The backing sheet may thus comprise a disposable membrane, preferably comprising a paper material, and the plurality of RFID tags are preferably attached to the backing sheet to expose a polymeric layer of the plurality of RFID tags. The disposable membrane is preferably at least partially translucent.

Preferably the array comprises a plurality of RFID tags arranged sequentially in an elongate strip with adjoining or substantially adjacent longitudinal edges.

Preferably the adjoining or adjacent longitudinal edges of adjacent RFID tags are defined by transverse perforations in the backing sheet between adjoining RFID tags or a spacing between the adjacent RFID tags, respectively.

Preferably the RFID tag array further comprises indexing apertures along at least one edge of the backing sheet, and more preferably along opposing longitudinal edges of the backing sheet. More particularly, the indexing apertures are preferably provided in the backing sheet and are partitioned from the RFID tags by perforations in the backing sheet.

Alternatively, or additionally, there may be provided a space in the backing sheet between at least part of each of the adjoining or adjacent RFID tags.

In a seventh aspect, the invention may broadly be said to consist in a method for producing a plurality of radio frequency identification (RFID) tags in an array, comprising steps of:
providing a sheet of backing material;
providing a first sheet of adhesive material overlaying the backing material;
providing a plurality of RFID transponders and associated antennae on the first sheet of adhesive material;
providing a second sheet of material overlaying the first sheet of adhesive material and the plurality of RFID transponders and antennae;
laminating together the layer of backing material and the first and second layers of adhesive material; and
forming perforations in one or more of the layers, thereby partitioning the array into a plurality of RFID tags whereby individual RFID tags may be torn from the array along said perforations.

Preferably the backing material comprises a polymeric material.

Preferably the method further comprises a step of forming indexing apertures in the array along at least one edge of the backing material, and more preferably along opposing longitudinal edges of the backing material.

Preferably the method further comprises forming perforations in the backing material partitioning the indexing apertures from the plurality of RFID tags.

Alternatively, the method may further comprise a step of providing at least one gap or indent in the backing material adjacent each of the plurality of RFID tags.

Preferably the method further comprises a step of printing to the backing material.

The step of printing to the backing material preferably comprises conveying the material through a printer by engaging one or more of the indexing apertures. The indexing apertures may be engaged by a rotating sprocket, for example.

Preferably the step of printing to the backing material further comprises aligning a print head of a printer with each of the plurality of RFID tags using an optical sensing means aligned with the indexing apertures, gaps, or indents.

Preferably the method further comprises wrapping the array about a substantially transverse axis into a roll arrangement. In particular, the array is preferably wrapped about a substantially cylindrical core.

In an eighth aspect, the invention may broadly be said to consist in a method for producing a radio frequency identification (RFID) tag array, comprising removably adhering a plurality of RFID tags to a disposable membrane with a spacing between adjacent RFID tags. The RFID tags are preferably, but not necessarily, produced according to the method of the third aspect of the invention.

Preferably the disposable membrane is at least partially transparent.

Preferably the disposable membrane comprises a paper material.

Preferably the method further comprises a step of printing to one or more of the plurality of RFID tags. The step of printing preferably further comprises aligning a print head of a printer with each of the plurality of RFID tags using an optical sensing means adapted to detect the spacing between adjacent RFID tags.

In a ninth aspect, the invention may broadly be said to consist in a radio frequency identification (RFID) tag comprising:
a backing layer;
an RFID transponder attached to the backing layer; and
an antenna attached to the backing layer and inductively coupled with the RFID transponder, the antenna comprising an elongate wire arranged to have a substantially central looped portion and arcuate portions towards opposing ends of the elongate wire.

Preferably the antenna is further arranged to have substantially linear intermediate portion between the central looped portion and each of the arcuate portions. The wire preferably terminates with opposing ends facing each other and the central looped portion, parallel with the substantially linear intermediate portions. In a tenth aspect, the invention may broadly be said to consist in a radio frequency identification (RFID) tag comprising an RFID transponder laminated and hermetically sealed between at least two sheets of fluid-impervious material.

Further aspects of the invention, which should be considered in all its novel aspects, will become apparent from the following description.

### DRAWING DESCRIPTION

A number of embodiments of the invention will now be described by way of example with reference to the drawings in which:

FIG. 1 is an exploded diagram of a first embodiment of a laundry RFID tag according to the present invention;

FIG. 2 is a diagrammatic exploded profile view of the layers and components of the RFID tag of FIG. 1;

FIG. 3(a)-(d) illustrates four possible antennae suitable for use with the RFID tag of FIGS. 1 and 2;

FIG. 4 is an exploded diagram of a second embodiment of an RFID laundry tag according to the present invention;

FIG. 5 is an exploded diagram of a third embodiment of an RFID laundry tag according to the present invention;

FIG. 6 is an exploded diagram of a fourth embodiment of an RFID laundry tag according to the present invention;

FIG. 7 is a diagram of an array of RFID tags according to a second embodiment of the invention;

FIG. 8 is a reverse view of an alternative array of RFID tags according to the invention;

FIG. 9 is a diagram of yet another alternative array of RFID tags according to the present invention; and

FIG. 10 illustrates an antenna stitched to a reinforced adhesive layer in accordance with some embodiments of the invention.

### DETAILED DESCRIPTION OF THE DRAWINGS

Throughout the description like reference numerals will be used to refer to like features in different embodiments. Although the invention will be described below with reference to preferred embodiments suitable for use as laundry tags for convenience, it is to be understood that the invention is not necessarily limited to such an application.

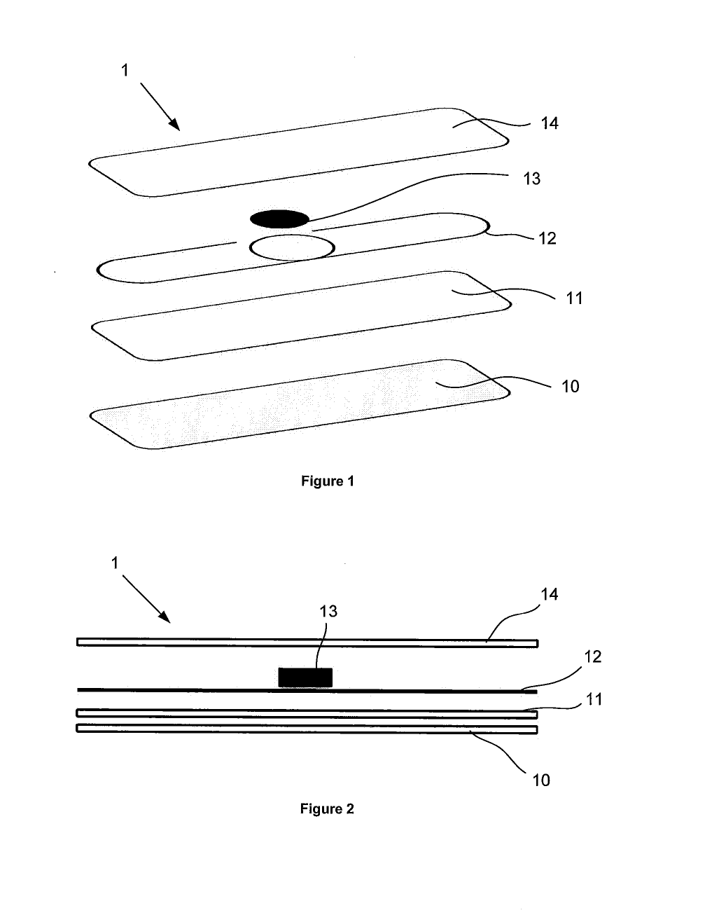

Referring first to FIG. 1, there is shown an exploded diagram of an RFID laundry tag according to a first embodiment of the invention. The illustrated RFID tag 1 comprises a polymeric backing layer 10, a first adhesive layer 11 overlaying the polymeric backing layer, an antenna 12 provided atop the first adhesive layer, an RFID transponder electronic circuit 13 also provided atop the first adhesive layer preferably in substantially the same plane as the antenna, and a second adhesive layer 14 overlaying the first adhesive layer, antenna, and RFID transponder. The various layers or components of the RFID tag are also illustrated in cross-section in FIG. 2.

The polymeric backing layer 10 preferably comprises a substantially fluid-impervious non-hygroscopic polymeric material which may comprise polyvinyl chloride (PVC), low-density polyethylene (LDPE), polyurethane (PU), polyester, or more preferably polypropylene (PP), although any other suitable polymeric material may alternatively be used. One advantage of this polymeric backing layer, compared to the poly-cotton backing layer of the prior art, is that it is highly resistant to discolouration from the adhesive reacting to bleach and/or heat during washing or drying of laundry articles. The polymeric backing layer 10 preferably comprises a printable medium, and in particular a thermo-printable medium.

The first adhesive layer 11 preferably comprises a fluid-impervious heat-activated adhesive such as polyurethane or an acrylic polymer. Acrylic polymers in particular have been found to provide a strong and durable adhesive capable of withstanding the rigours of the repeated washing, drying, and/or ironing/pressing cycles to which laundry articles are subjected.

The antenna 12 in this preferred embodiment comprises a booster antenna coupled to the RFID transponder electronic circuit 13 by induction, thereby avoiding a direct electrical connection which may be prone to failure from fatigue due to repeated bending. However, a direct electrical connection may alternatively be used without departing from the scope of the invention.

The antenna 12 preferably comprises a multi-strand stainless steel wire encapsulated in a nylon or other polymer insulation. Such a multi-strand wire structure measuring 0.3-0.5 mm in diameter with 49 strands has been found to have sufficient flexibility and be less prone to kinking than the antennae of the prior art. However, in other embodiments the antenna may alternatively comprise any other stranded or solid-core wire without departing from the scope of the invention. The choice of wire structure may also take into account the conflicting objectives of longer operating distances achieved with larger diameter wire and the reduced thickness of the RFID laundry tag which is permitted by a narrow wire.

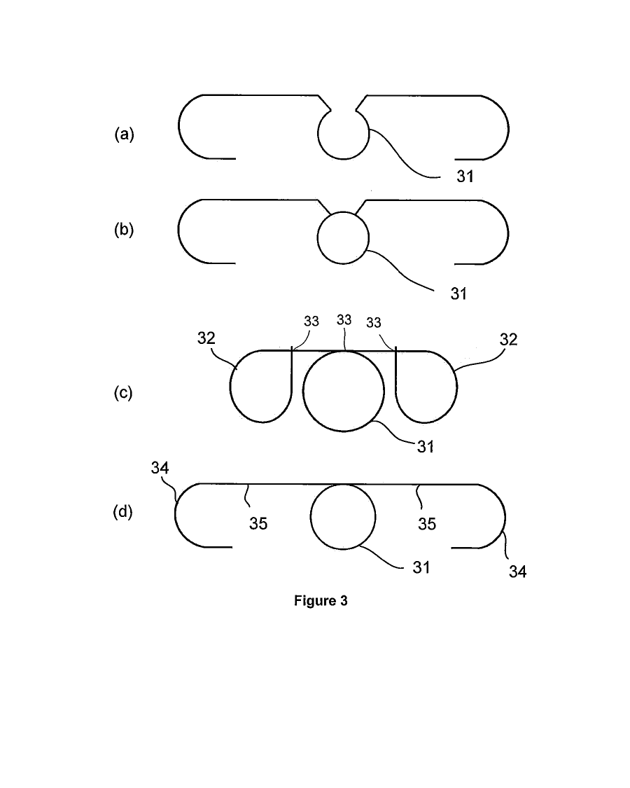

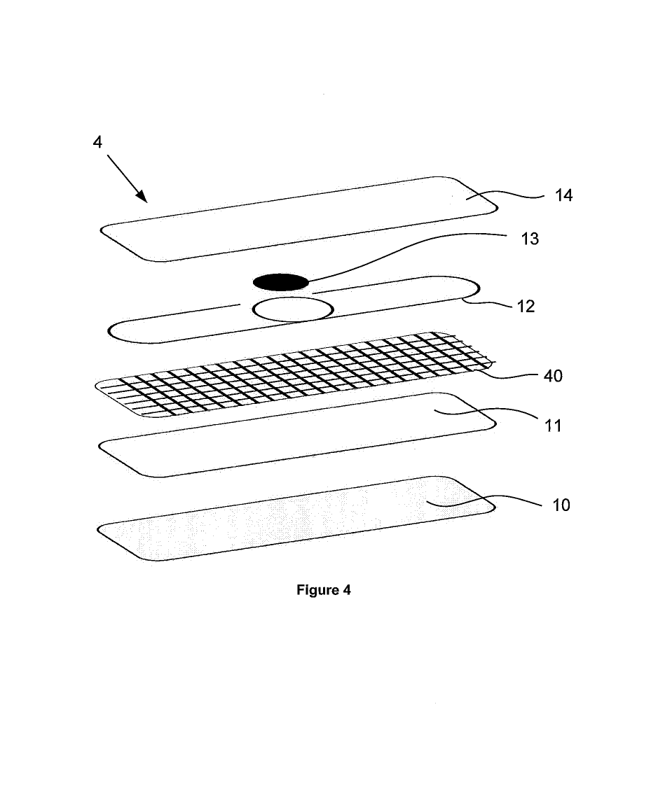

The antenna 12 is not limited to the shape shown in FIG. 1 and in further detail in FIG. 3(d). Alternative antennae are shown in FIGS. 3(a), (b) and (c), and many other alternatives are also possible without departing from the scope of the invention. However, where the antenna is inductively coupled with the RFID transponder, the antenna preferably has a central portion 31 which is substantially looped to loop at least part way around the RFID transponder to provide a good inductive coupling. The antenna 12 is a far-field antenna, inductively coupled with a near-field antenna integrated in the RFID transponder 13.

The RFID transponder or “coin” 13, which may be provided on a printed circuit board for example, preferably comprises an aperture therein. When the layers of the RFID tag 13 are laminated or bonded together, the adhesive melts and flows into the aperture where it cures of solidifies to aid in securing the transponder 13 in position.

An antenna shape which may be useful in certain embodiments of the invention is shown in FIG. 3(c), in which the antenna comprises three loops formed from a single wire with an end loop 32 either side of the central loop 31 of the previous examples. The wire is preferably attached to itself at the three points 33 where it crosses over itself to form each of the three loops. This attachment secures the shape of the antenna, thereby holding the antenna substantially in the required shape during lamination between the adhesive layers. Testing has shown the antenna of FIG. 3(c) to also provide a good read range.

In other embodiments of the invention, as described in further detail below, the antenna may be held in shape by other means and alternative antenna shapes may therefore be preferred. The antenna shape of FIG. 3(d) is preferred in such embodiments. The antenna comprises a central looped portion 31, and arcuate portions 34 towards opposing ends of the antenna with respect to the central looped portion 31. Opposing ends of the wire preferably terminate facing each other and the central looped portion 31, parallel with substantially linear intermediate portions 35.

In yet other embodiments, the antenna 12 may comprise a foil antenna rather than the wire antenna shown in the drawings of FIGS. 1 and 2.

Referring again to FIGS. 1 and 2, the RFID transponder 13 preferably comprises a passive RFID circuit, in this embodiment shown in a coin or disc form. The antenna 12 preferably loops at least partially around the circuit 13 to provide the inductive coupling. The RFID circuit may be either read-only or read/write capable, and may be assigned a serial or identification number either at the point of manufacture or in the field by the user without departing from the scope of the invention.

The second adhesive layer 14 is preferably a heat-activated adhesive, like the first adhesive layer 11.

During manufacture, the polymeric backing layer 10, first adhesive layer 11, antenna 12, RFID coin 13 and second adhesive layer 14 are preferably arranged in the order indicated, then bonded together by thermal or ultrasonic welding, for example, to hermetically seal the RFID coin 13 and associated antenna 12 within the RFID tag. That is, the RFID antenna 12 and RFID coin 13 are sandwiched or laminated between the adhesive layers 11, 14. Before bonding of the layers, the antenna may be stitched to the adhesive using a cotton or poly-cotton thread, either at discrete points or continuously along the length of the antenna. Alternatively, a polyurethane or other polymer thread may be used which may melt upon lamination to disappear entirely or meld with the adhesive layers. However, when the antenna is to be stitched to an adhesive layer, it may be preferable to use a reinforced adhesive layer as described in the further detail below.

The adhesive layers are preferably flexible and electrically and environmentally insulate the RFID electronics despite repeated flexing of the laundry tag during repeated use, washing, drying, and/or ironing/pressing cycles. In other embodiments, as described in further detail below, one of the adhesive layers may be reinforced to improve the reliability of the RFID tag.

The overlaying polymeric backing layer 10, first adhesive layer 11 and second adhesive layer 14 are preferably substantially co-extensive in this embodiment, but in other embodiments the various layers need not necessarily be co-extensive provided that a watertight hermetic seal may be formed about the electronics upon bonding.

One of the advantages of this bonding is that the RFID antenna 12 and RFID transponder 13 are securely positioned in relation to one another. This prevents or at least ameliorates their relative movement which may occur during repeated washing, drying (in particular pressure drying), and ironing cycles, and has been found to lead to failure in the RFID laundry tags of the prior art. In particular, there is a risk that the relatively rigid RFID coin (comprising a rigid printed circuit board) may shift to a position atop the antenna. Repeated flexing of the antenna at the point adjacent the edge of the rigid RFID coin has been found to lead to breakages in antennae. Relative movement will also compromise the inductive coupling between the RFID transponder and antenna.

The RFID laundry tag of FIG. 1 may be attached to a laundry article (including at least garments and linens, for example) by positioning it on the laundry article with the second adhesive layer 14 against the fabric of the laundry article, and temporarily applying heat sufficient to adhere the laundry tag (or, more specifically, the second adhesive layer) to the article. The laundry tag 1 is thus suitable for both rapid retrofitting and application during manufacture of goods.

The reverse side of the laundry tag of this embodiment, i.e. the exterior side of the polymeric backing layer 10, may be printed with markings. The particular markings printed upon the laundry tag may be selected by the RFID tag manufacturer or a customer, and may comprise one or more of a logo or other image; a supplementary visual identification means; and/or text such as care instructions, for example. The supplementary visual identification means might comprise a unique serial or identification number or a bar-code possibly but not necessarily corresponding with the serial number of the RFID coin 13. The markings may also assist in disguising the RFID tag as merely a common label devoid of RFID capabilities. The printing process may use a two colour nylon ink system which can be heat-sealed onto the polymeric backing layer, for example. However, any other printing process may alternatively be used, including but not limited to thermal transfer, inkjet, or laser printing.

FIG. 4 illustrates a variation of the embodiment of FIGS. 1 and 2, in which the RFID tag 4 comprises a reinforced adhesive layer comprising reinforcing mesh 40. The reinforcing mesh 40 may comprise a woven polyester or poly-cotton textile, for example, although other materials and/or processes (e.g. extrusion) may alternatively be used in forming a suitable mesh.

Although shown as a separate layer in the exploded diagram for illustrative purposes, the reinforcing mesh 40 is preferably embedded at least in part in an adhesive layer, most preferably the first adhesive layer 11, prior to lamination of the layers. Alternatively, the reinforcing mesh may comprise a separate layer. The separate reinforcing layer may become at least partially embedded in an adhesive layer upon bonding/lamination of the RFID tag.

The antenna 12 is preferably stitched to the reinforced adhesive layer (or, more specifically, the reinforcing mesh 40 thereof) prior to lamination. This is illustrated in FIG. 10, which shows the antenna 12 stitched to a reinforced adhesive layer continuously along its length by stitching 101. The antenna may alternatively be stitched to the reinforced adhesive layer at a plurality of discrete points.

The stitching 101 may comprise a cotton, poly-cotton, or other substantially durable thread, and preferably holds the antenna in position during lamination and, in combination with the reinforcing mesh 40, subsequent use of the RFID tag.

In other embodiments, the stitching 101 may be required merely to hold the antenna 12 in position before and/or during lamination, and a polyurethane or other perishable polymer thread which melts upon lamination may alternatively be used. Alternatively, as described above the antenna may be stitched to a non-reinforced adhesive layer using a durable or perishable thread. However, the combination of durable stitching and reinforcing has been found to provide the dual advantages of securing the antenna in the required shape during lamination, and negating the potential problem of excess pliability of the adhesive layer due to heat, which may permit movement and deformation of the antenna in particular during ironing/pressing of laundry articles using heated rollers. Such deformation can compromise the performance of the antenna in use.

Since the antenna is secured in the desired shape by the reinforcing during lamination, the antenna shape of FIG. 3(d) may be preferred over that of FIG. 3(c) in this embodiment, although any suitable antenna shape may be used without departing from the scope of the invention.

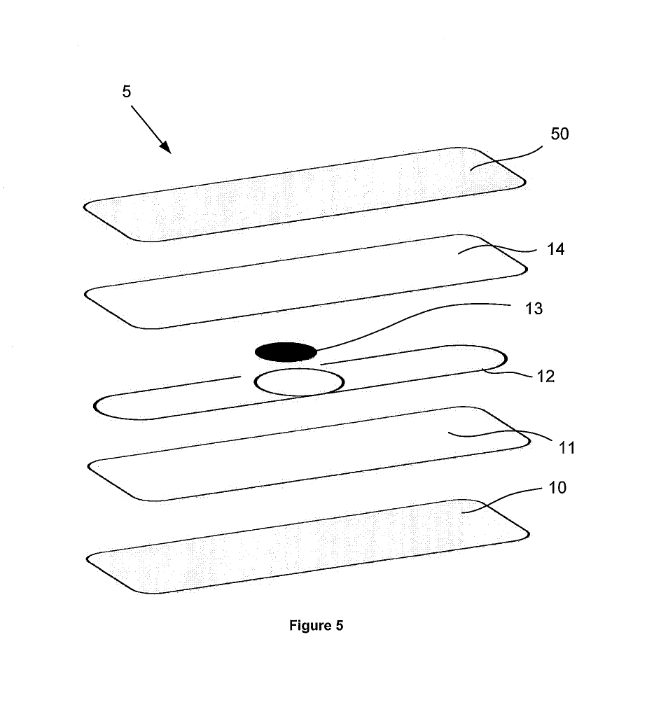

The RFID tag embodiments of FIGS. 1 and 4 having an exposed adhesive layer are most suitable for heat-sealing to a laundry article, whereby only a single side of the RFID tag will generally be visible following attachment to the laundry tag. Referring to FIG. 5 there is shown another embodiment of an RFID tag 5 according to the invention which may be preferred in circumstances where the tag is to be stitched or sewn onto a laundry article, generally along one edge of the tag whereby both sides may be visible.

The example RFID tag 5 is identical in all respects to the embodiment of FIG. 1, with the exception that it is provided with an additional outer polymeric layer, outer layer 50, opposing the polymeric backing layer 10. The adhesive layers 11, 14, RFID transponder 13 and antenna 12 are therefore laminated between the polymeric backing and outer layers 10, 50 which in this embodiment form the outermost layers of the RFID tag 5. Markings may be printed to the outer surfaces of either or both of the polymeric backing and outer layers 10, 50.

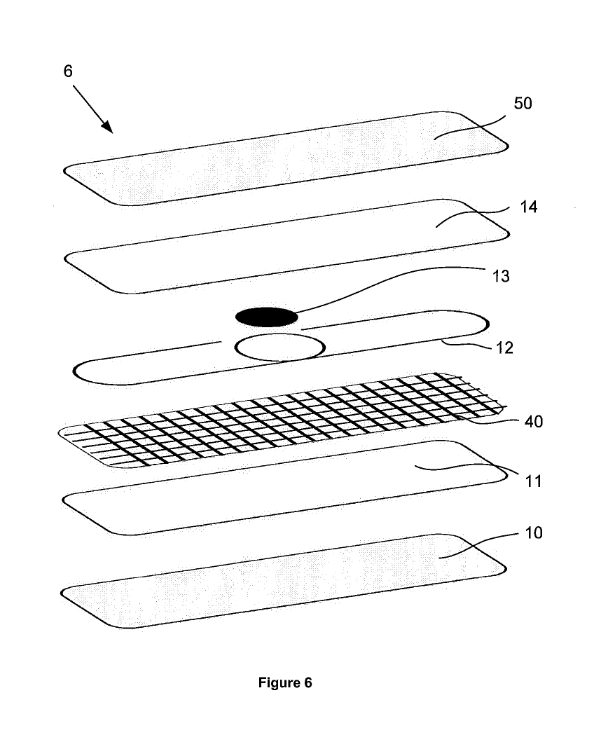

FIG. 6 shows an RFID tag 6 comprising a variation of the embodiment of FIG. 5 in the addition of reinforcing as described above with respect to FIG. 4.

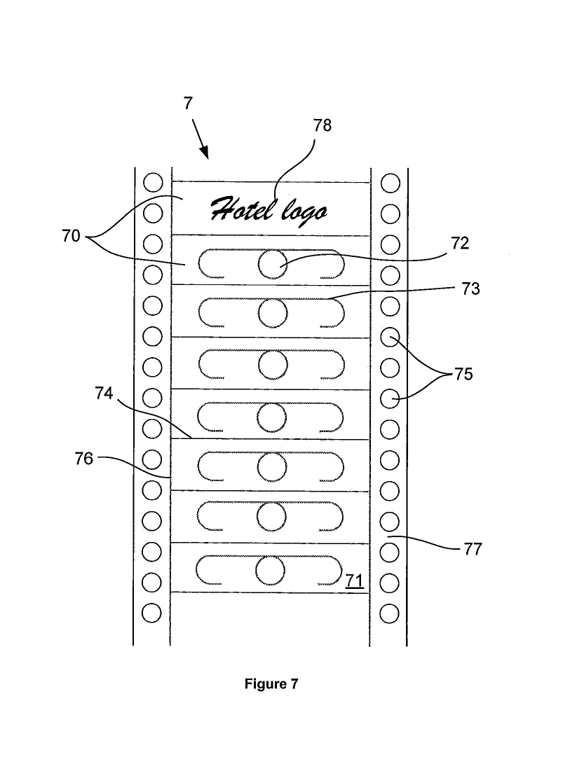

In another aspect, the invention consists in a plurality of RFID tags provided in an array 7 as shown in FIG. 7.

More particularly, the array of RFID tags 7 is preferably provided to customers in a fan-fold or more preferably a roll arrangement (not shown) by folding or rolling the array appropriately. A roll or reel is generally preferred, and the array may be wrapped around a tubular or cylindrical paperboard core, spool, reel, or similar, which may be placed in a dispenser to provide a substantially continuous supply of RFID tags. The array thus arranged is particularly convenient for printing markings and potentially also automating application of the individual RFID tags to laundry articles (or other items) as will be apparent from the following description.

The RFID tag array 7 preferably comprises a plurality of RFID tags provided on a single substantially planar unitary backing sheet 71. Individual RFID tags 70 in the example embodiment of the invention shown in FIG. 7 are substantially rectangular and arranged sequentially side-by-side in a single row or strip, adjoined with adjacent tags along the adjacent longitudinal sides. Each RFID tag 70 comprises at least an RFID transponder electronic circuit 72, an antenna 73, and a portion of the sheet of backing material upon which the RFID transponders and associated antennae are affixed. Each individual RFID tag 70 is preferably separably partitioned from the adjacent tag(s) by transverse perforations 74 in the backing sheet, whereby individual RFID tags may be torn from the array for application to a laundry article, for example.

It will be appreciated that the term “unitary” means that a single contiguous sheet of material forms the corresponding layers of the plurality of individual RFID tags. The unitary sheet itself may comprise a plurality of woven fibres.

The term “perforations” is used herein in the broad sense of indicating a line of weakness facilitating simple removal of individual RFID tags 70 from the array 7. The perforations may thus preferably comprise a linear series of closely-spaced incisions each cutting entirely through the backing sheet 71, but may alternatively comprise a single partial incision or “score” line through the backing sheet, any other such weakening of the material, or combinations thereof facilitating a substantially straight tear for separation and removal of individual RFID tags 71 from the array.

The RFID tag array 7 preferably also comprises a plurality of indexing apertures 75 in the backing sheet 71, ideally along opposing longitudinal edges or sides of the array. The apertures 75 may be formed by punching apertures through the backing sheet, for example. The apertures 75 are preferably also partitioned from the RFID tags 70 by perforations 76 for easy removal of the RFID tags 70 and/or apertures 75 from the array 7.

The indexing apertures 75 enable the use of a sprocket- or tractor-feed arrangement for continuously conveying the array 7 through machinery (e.g. from a dispenser allowing the roll to rotate), whereby a rotating sprocket engages the apertures to feed the array forward (or backwards, if required). This ensures that tags 70 are continuously and consistently presented to the machinery in the correct orientation and at the required rate. It also avoids unnecessary pressure upon the RFID tags 70 which might be created by a friction feed arrangement in which the array 7 is passed between a pair of parallel rollers. Such pressure may shift the RFID coin with respect to the antenna, which may result in breakage of the antenna or compromise the inductive coupling between the RFID transponder and antenna as described previously.

Alternatively, or additionally, the indexing apertures 75 may provide a means for sensing the passage of the RFID tag through a printer or other automated machinery for synchronisation. In particular, an optical sensing means comprising a light source and light sensor provided on opposing sides of the array 7 and aligned with the apertures 75 may automatically provide an indication of the position of the array 7 and/or individual tags 70 with respect to the machinery. The indexing apertures 75 may therefore be provided in a specific position with respect to each RFID tag 70 to facilitate correct alignment of a print head or other such device for accurate positioning of printed markings or the like upon each tag. Similarly, the indexing apertures 75 may be used to ensure the correct formation of perforations in the backing sheet 71 without cutting the antennae, for example.

The machinery may thus comprise a printer for applying markings 78 to the backing sheet 71. It may alternatively or additionally comprise machinery for automatically applying the RFID tags to items such as laundry articles, whether upon retrofitting or during original manufacture of the items, and/or machinery for manufacturing the array 7 itself, including forming the perforations.

The RFID tags 70 of the array 7 may comprise RFID laundry tags substantially as described herein with respect to any of FIGS. 1-6, but may alternatively comprise any other RFID tag, potentially including at least those of the prior art having a poly-cotton backing, for example. Similarly, the RFID tags of the first aspect of the invention need not necessarily be produced or sold in arrays as described with respect to this aspect of the invention, but may alternatively be produced and/or sold individually without departing from the scope of the invention.

Where the RFID array 7 comprises a plurality of the tags 1 of FIGS. 1 and 2, for example, the method preferably comprises providing the polymeric backing layer 10 and first and second adhesive layers 11, 14 in sheet form having a size commensurate with the number of tags 70 to be provided in the array. The polymeric backing layer 10 in this case forms the backing sheet 71 of the array, which should also be of a size sufficient to accommodate the tear-off indexing aperture strips 77, if required. However, the remaining layers (i.e. adhesive layers) need not necessarily extend atop the indexing aperture strips 77. A plurality of RFID transponders and associated antennae are provided between the adhesive sheets, which are then bonded together with the polymeric backing sheet. The perforations are preferably then formed in the backing sheet 71 (and adhesive layers, where necessary). Indexing apertures may generally be formed (e.g. punched) in the backing sheet at any stage of the process.

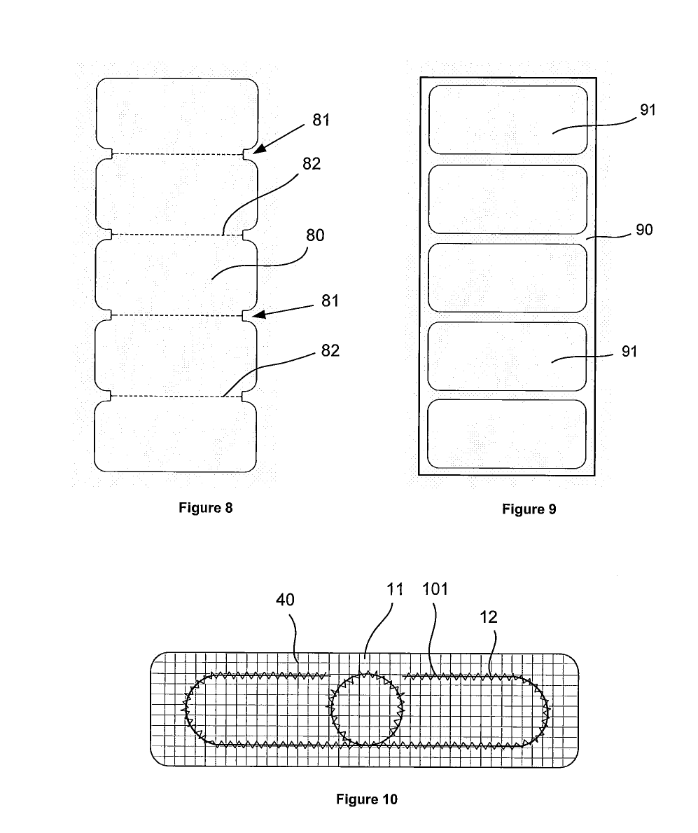

An alternative RFID tag array according to the present invention is shown in a reverse view in FIG. 8. In this embodiment, the backing sheet 80 again forms the polymeric backing layer of the RFID tags but omits the indexing apertures 75 of FIG. 7. In place of the indexing apertures, the backing sheet 80 has gaps or indents 81 between the backing layers of adjacent RFID tags. As before, the separable individual RFID tags can be removed from the array by tearing along transverse perforations 82 extending between indents 81 on opposing sides of the array, along the adjoining longitudinal edges of consecutive RFID tags.

The indents 81, in this case provided at opposing ends of the adjoining longitudinal edges of consecutive RFID tags, again provide a means for sensing the passage of the RFID tag through a printer or other automated machinery to identify the beginning and/or end of each RFID tag of the array as the array is fed through the machinery in the longitudinal direction, to ensure that printed markings, for example, are correctly and consistently aligned on each tag. The indents 81 may additionally, or alternatively, be engaged by a sprocket- or tractor-feed system to convey the array through the machinery.

Yet another alternative backing sheet suitable for an RFID array according to the present invention is shown in FIG. 9. In this embodiment, the backing sheet preferably comprises a disposable elongate carrier membrane 90 to which individual RFID tags are removably attached using an adhesive (e.g. a pressure-sensitive adhesive), preferably with a spacing between consecutive RFID tags 91. Consecutive RFID tags in the array preferably have substantially adjacent longitudinal or elongate edges separated by the spacings, as shown. Individual RFID tags 91 can therefore be selectively removed from the array as required, without the need for the perforations of the preceding embodiments.

The disposable membrane 90 is preferably made from an at least partially translucent paper material, whereby an optical sensing means can again be used to detect the spacing between opaque RFID tags by sensing light transmitted through the membrane 90 between consecutive RFID tags. It is disposable in the sense that, unlike the preceding embodiments of the invention, the membrane itself forms no part of the individual RFID tags. When all RFID tags 91 are removed from the membrane, the membrane may therefore be disposed of, reused, or recycled.

In this embodiment, the RFID tags are preferably removably attached to the membrane 90 with the polymeric backing layer (or outer layer) exposed. Printed markings can therefore be applied to the exposed side of the polymeric layer after it is applied to the membrane 90, which will be visible when the tags are applied to a laundry article. Alternatively, the polymeric backing layer may be removably adhered to the disposable membrane.

Although the RFID tag arrays described herein and shown in the drawings comprise a single elongate row of tags, the tag array may alternatively comprise a plurality of rows of RFID tags without departing from the scope of the invention.

The RFID tags and/or tag arrays of the present invention are preferably provided with printed markings by way of a thermal transfer printing process. However, inkjet, laser, or any other type of printer may alternatively be used.

A large number of variations or modifications to the example RFID laundry tags and tag arrays described above are possible without departing from the scope and spirit of the invention. Several illustrative examples of such variations are described below.

In one embodiment, the RFID laundry tag of FIGS. 1 and 2 may additionally be provided with a poly-cotton or similar textile layer atop the second or outer adhesive layer. There are several reasons why such a textile layer may be desired by a customer. Firstly, the textile layer may be embroidered. Secondly, the textile layer may extend beyond the backing and adhesive layers in at least one direction to provide a flap whereby the laundry tag may be sewn onto a laundry article. Thirdly, the air permeability of the textile layer may prevent the accumulation of air bubbles between layers which must be dissipated to avoid problems during lamination.

RFID tags of the present invention are not limited only to the layers described in the example embodiments above. In particular, the outer polymeric layer of the embodiment of FIG. 5 need not necessarily be the outermost layer of the tag—the outer polymeric layer may be merely provided outwardly with respect to the inner adhesive layers and electronics. One (or both) of the polymeric layers may be provided with an additional adhesive layer on their outer side, whereby the RFID tag may be heat-sealed in place after being sewn into the hem of bed linens, for example, to prevent movement within the hem. The laundry tag may optionally be ultrasonically welded around the outer edge for improved durability and reliability.

In yet other embodiments, the antenna may be electrically coupled with the transponder, rather than inductively coupled.

From the foregoing it will be seen that an RFID tag and RFID tag array are provided which, in various embodiments, overcome or ameliorate one or more of a variety of problems with the prior art. The laundry tags of the present invention are suitable for either retrofitting or application to items upon original manufacture. The RFID tags having a polymeric backing are highly resistant to the problem of discolouring which plagues the poly-cotton laundry tags of the prior art. The tags are also highly durable and reliable due to one or more of the flexible antenna; inductive coupling with the transponder; secure lamination of the transponder and antenna between adhesive layers; and/or stitching of the antenna to a reinforced adhesive layer. The antenna is not stitched to the backing material, but discretely laminated together with the RFID transponder beneath an outer polymeric layer, without any visible antenna stitching, at least once the tag is attached to a laundry article. The outer polymeric layer may be conveniently printed on to provide additional visual markings. The optional provision of tags in a roll or other array which can be conveniently fed through a printer or other machinery, simplifying customisation of the laundry tags and/or helping automate the manufacture and/or application of large numbers of tags.

Although this invention has been described by way of example and with reference to possible embodiments thereof, it is to be understood that modifications or improvements may be made thereto without departing from the scope of the invention. The invention may also be said broadly to consist in the parts, elements and features referred to or indicated in the specification of the application, individually or collectively, in any or all combinations of two or more of said parts, elements or features. Furthermore, where reference has been made to specific components or integers of the invention having known equivalents, then such equivalents are herein incorporated as if individually set forth.

Unless the context clearly requires otherwise, throughout the description, the words “comprise”, “comprising”, and the like, are to be construed in an inclusive sense as opposed to an exclusive or exhaustive sense, that is to say, in the sense of “including, but not limited to”.

Any discussion of the prior art throughout the specification should in no way be considered as an admission that such prior art is widely known or forms part of common general knowledge in the field.

1-35. (canceled)

36. A radio frequency identification (RFID) tag comprising:
a backing layer;
a first adhesive layer overlaying the backing layer;
an RFID transponder coupled to an antenna, overlaying the first adhesive layer; and
a second adhesive layer overlaying the RFID transponder and antenna.

37. The RFID tag of claim 36, further comprising an outer layer overlaying the second adhesive layer.

38. The RFID tag of claim 36, wherein the first and second adhesive layers hermetically seal the RFID transponder and the antenna within the RFID tag.

39. The RFID tag of claim 36, wherein the backing layer and/or outer layer comprise a fluid-impervious, non-hygroscopic polymeric material.

40. The RFID tag of claim 36, wherein the first and second adhesive layers comprise a heat-activated adhesive material.

41. The RFID tag of claim 36, wherein at least one of the first and second adhesive layers comprises a reinforced adhesive layer.

42. The RFID tag of claim 36, wherein the antenna comprises an elongate conductive wire stitched to one of the first or second adhesive layers.

43. The RFID tag of claim 36, wherein the RFID transponder is inductively coupled with the antenna, and the antenna loops at least partially about a circumference of the RFID transponder.

44. A radio frequency identification (RFID) tag array comprising a plurality of adjacent separable RFID tags according to claim 36.

45. The RFID tag array of claim 44, wherein the plurality of RFID tags are removably attached to a disposable membrane with a spacing between adjacent RFID tags.

46. A method for producing a radio frequency identification (RFID) tag, comprising:
providing consecutive layers of a backing layer, a first adhesive layer overlaying the backing layer, an RFID transponder and an associated antenna overlaying the first adhesive layer, and a second adhesive layer overlaying the RFID transponder and the antenna; and
bonding the backing layer and adhesive layers together to hermetically seal the RFID transponder and antenna within the RFID tag.

47. The method of claim 46, further comprising providing an outer layer overlaying the second adhesive layer, and bonding the outer layer to the second adhesive layer.

48. The method of claim 46, further comprising stitching the antenna to one of the adhesive layers prior to bonding the layers together.

49. The method of claim 46, wherein at least one of the first and second adhesive layers comprises a reinforcing mesh and the method further comprises stitching the antenna to the reinforcing mesh prior to bonding the layers together.

50. The method of claim 46, further comprising printing on the polymeric backing and/or outer layer.

51. The method of claim 46, further comprising attaching the RFID tag to a laundry article.

52. The method of claim 46, further comprising producing a plurality of RFID tags by providing substantially unitary backing and first and second adhesive sheets, wherein portions of the polymeric backing and first and second adhesive sheets form respective polymeric backing and first and second adhesive layers of the plurality of RFID tags.

53. The method of claim 52, further comprising providing perforations in at least one of the backing or first and second adhesive sheets to partition the plurality of RFID tags.

54. The method of claim 52, further comprising providing a plurality of indexing apertures along at least one edge of at least one of the sheets.

55. The method of claim 46, further comprising producing a plurality of individual RFID tags and removably attaching the plurality of RFID tags to a disposable membrane.
